(19) United States
(12) Patent Application Publication
(10) Pub. No.: US 2012/0131243 A1
(43) Pub. Date: May 24, 2012

(54) MULTIPLEXING PIN CONTROL CIRCUIT FOR COMPUTER SYSTEM

(75) Inventor: Hai-Yi JI, SHANGHAI (CN)

(73) Assignee: INVENTEC CORPORATION, TAIPEI CITY (TW)

(21) Appl. No.: 13/031,624

(22) Filed: Feb. 22, 2011

(30) Foreign Application Priority Data
Nov. 24, 2010 (CN) 201010569107.X

(51) Int. Cl. G06F 13/10

(52) U.S. Cl. 710/63

(57) ABSTRACT

A multiplexing pin control circuit for a computer system with multiple chips is provided, and includes a Southbridge chip having at least one multiplexing pin; at least one control module including a first connecting terminal electrically connected to the multiplexing pin, a second connecting terminal, and a control end receiving an enable signal; and a peripheral apparatus having an input/output (I/O) interface electrically connected to the second connecting terminal. When the enable signal is at a first level or a second level, the peripheral apparatus is electrically isolated from or connected to the second connecting terminal correspondingly. The control module switches on or switches off an electrical connection of the multiplexing pin with an external circuit, thereby avoiding an interference with a level voltage of the multiplexing pin during an initialization and reset period and further ensuring the multiplexing function of the pin during a normal operation period.

### RELATED APPLICATIONS

This application claims priority to China Application Serial Number 201010569107.X, filed Nov. 24, 2010, which is herein incorporated by reference.

### BACKGROUND

1. Field of Invention

The present invention relates to a multiplexing pin for a computer system. More particularly, the present invention relates to a multiplexing pin control circuit for a computer system.

2. Description of Related Art

Currently, a multiplexing pin of a computer system may suffer an external interference from a second function used by the pin when being initialized, and the interference will produce a certain influence on an electrical level voltage signal of the pin and even cause a system initialization error, thus reducing the operation reliability of the system.

In view of this, it has become a to-be-addressed subject for those skilled in the art to design a stable and reliable control circuit directed to the aforementioned defects of the multiplexing pin in terms of time-division multiplexing.

### SUMMARY

Directed to the signal interference produced in the time-division multiplexing of the multiplexing pin in the prior art, the present invention provides a multiplexing pin control circuit for a computer system. According to an aspect of the present invention, a multiplexing pin control circuit for a computer system is provided, in which the computer system has multiple chips. The control circuit includes:

a Southbridge chip having at least one multiplexing pin;

at least one control module each of which includes:
a first connecting terminal electrically connected to the multiplexing pin;
a second connecting terminal; and
a control end for receiving an enable signal; and

a peripheral apparatus having an input/output (I/O) interface electrically connected to the second connecting terminal.

When the enable signal is at a first level, the peripheral apparatus and the second connecting terminal are electrically isolated from each other, and an operation mode of the multiple chips is determined according to a level value of the multiplexing pin. When the enable signal is at a second level, the peripheral apparatus and the second connecting terminal are electrically connected, and the multiplexing pin serves as a data output of a Universal Serial Bus (USB).

Preferably, the peripheral apparatus is a complex programmable logic device (CPLD).

Preferably, the control module further includes a metal oxide semiconductor field effect transistor (MOSFET). Furthermore, a source of the MOSFET is connected to the first connecting terminal, and a drain of the MOSFET is connected to the second connecting terminal, and a gate of the MOSFET is connected to the control end.

In an embodiment, when the computer system is initialized, the enable signal is at the first level. Preferably, when the enable signal is at the first level, the MOSFET stays in an off state, and the first connecting terminal and the second connecting terminal are electrically isolated from each other. In another embodiment, when the computer system works normally, the enable signal is at the second level. Preferably, when the enable signal is at the second level, the MOSFET stays in an on state, and the first connecting terminal and the second connecting terminal are electrically communicated with each other.

Preferably, the enable signal is sent by the Southbridge chip.

The control circuit of the present invention adopts the control module such as an MOSFET to switch on or switch off an electrical connection between the multiplexing pin and an external circuit, thereby avoiding an interference with the level voltage of the multiplexing pin during an initialization and reset period so as not to affect the mode setting during the system initialization, and further ensuring the enablement of the multiplexing function of the pin during a normal operation period. Therefore, the maintenance cost of the system is reduced and the stability and reliability of the operation are improved.

### BRIEF DESCRIPTION OF THE DRAWINGS

The present invention can be more fully understood by reading the following detailed description of the embodiments, with reference made to the accompanying drawings as follows:

FIG. 1 is a structural block diagram showing a control circuit according to a preferred embodiment of the present invention; and

FIG. 2 is a schematic view illustrating a circuit connection when the control circuit in FIG. 1 is applied to multiple multiplexing pins.

### DETAILED DESCRIPTION

With reference to the accompanying drawings, the embodiments of the present invention will be described in detail below.

When many existing integrated chips are adopted in designing various control or detection functions, the same one pin is usually designed to performing different functions at different time periods for reducing the number of pins required to be built on a chip externally. For example, the pin which is applied when the chip works normally is defined as a first function, and the pin in a certain time period (e.g. an initialization, reset, or establishing period) is defined as a second function. However, during the existing circuit design process, the specialized function switching or switching control is not designed on the multiplexing pin. As a result, the multiplexing pin during initialization is liable to be affected by an external interference, and the interference comes from a connection circuit which is applied when the multiplexing pin serves as the first function, thus causing the system to mistakenly determine an electrical level voltage of the pin, resulting in a system initialization failure and decreasing the operation stability and reliability. Taking a server as an example, an integrated chip inside the server generally has multiple input/output (I/O) ports and multiple built-in bit flags. In order to reduce the number of pins of the chip, the built-in bit flags normally share one pin with some I/O ports. For example, during initialization of the server system, a basic input output system (BIOS) or a power-up driver program needs to determine an electrical level voltage (high level or low level) state of some pins in the Southbridge chip and to set several operation modes of the chip or the system according to corresponding electrical level states. After a period of time, i.e. after the initialization of the system is completed, the pins are multiplexed to serve as another function (also referred to as the second function).

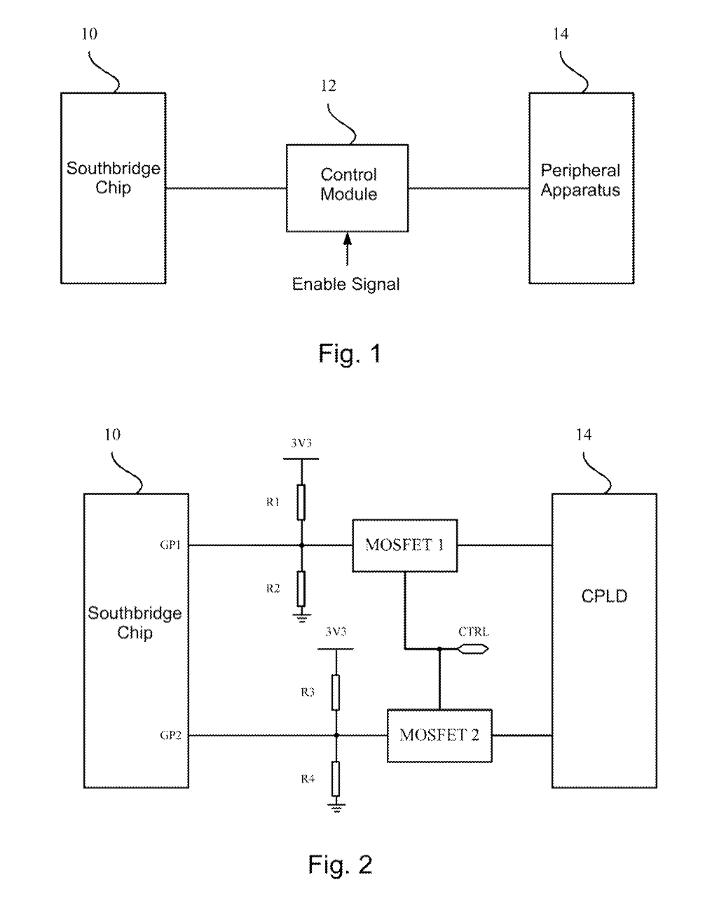

FIG. 1 is a structural block diagram showing a control circuit according to a preferred embodiment of the present invention. Referring to FIG. 1, the control circuit includes a Southbridge chip 10, a control module 12 and a peripheral apparatus 14. The Southbridge chip 10 has at least one multiplexing pin, and the multiplexing pin is electrically connected to the control module 12. In addition, the control module 12 is connected to an I/O port of the peripheral apparatus 14. For brief description, multiple interface ends of the control module 12 are classified into three types, wherein an interface end electrically connected to the multiplexing pin of the Southbridge chip 10 is referred to as “a first connecting terminal”; an interface end electrically connected to the I/O interface of the peripheral apparatus 14 is referred to as “a second connecting terminal”; and an interface end for providing the enable signal as shown in FIG. 1 is referred to as a control end of the control module 12. Preferably, the enable signal comes from the Southbridge chip 10.

As can be seen from FIG. 1, the control module 12 is disposed between the multiplexing pin of the Southbridge chip 10 and the corresponding I/O port of the peripheral apparatus 14. When the system operates normally and the multiplexing pin serves as the first-function pin, the first connecting terminal and the second connecting terminal are electrically communicated with each other, and thus the multiplexing pin is electrically coupled to the peripheral apparatus 14. When the system performs an operation such as initialization and the multiplexing pin serves as the second-function pin, the first connecting terminal and the second connecting terminal are electrically isolated from each other. Therefore, during the system initialization period, when the system reads an electrical level voltage of the pin, the voltage signal from the peripheral apparatus 14 does not cause any interference to the pin because the first connecting terminal and the second connecting terminal in the control module 14 are disconnected.

In order to further describe the operation principle of the control circuit of the present invention, FIG. 2 is a schematic view illustrating a circuit connection when the control circuit in FIG. 1 is applied to multiple multiplexing pins. Those of ordinary skills in the art should understand that, although only two multiplexing pins of the Southbridge chip and the corresponding pull-up circuits of the multiplexing pins are illustrated in FIG. 2, but the present invention is not limited thereto. For example, the present invention may be further applicable to another integrated chip or system having at least one multiplexing pin in addition to the Southbridge chip. Furthermore, those of ordinary skills in the art should understand that, although the control module in the control circuit of the present invention is shown by using a metal oxide semiconductor field effect transistor (MOSFET) as an example shown in FIG. 2, the control module of the present invention may be some other switching electronic element that can enable a switching control function and meet electric parameters, such as an NPN transistor, a PNP transistor, a CMOS transistor or a thin film transistor (TFT), which shall also fall within the scope of the present invention.

In the following description, a complex programmable logic device (CPLD) 14 is used as an example of the peripheral apparatus for illustrating the operation principle of the control circuit of the present invention. Resistors R1 and R2 form a pull-up circuit, and resistors R3 and R4 form a pull-up circuit, so as to respectively maintain port voltages at the pins GP1 and GP2 to be a high level or a low level. Furthermore, MOSFET1 and MOSFET2 are respective control modules of the pins GP1 and GP2, and CTRL is a control end of the two MOSFETs. In an embodiment, the first electrode of the MOSFET1 (or the MOSFET2) is electrically connected to the multiplexing pin GP1 (or GP2), and the second electrode of the MOSFET1 (or the MOSFET2) is electrically connected to an I/O interface of the CPLD 14. For example, the first electrode refers to a source or drain of the MOSFET1 (or the MOSFET2).

It is set that the first functions of the pins GP1 and GP2 of the Southbridge chip 10 respectively serve as a data input and a data output of the USB, and their second functions are closely related to a port level voltage during initialization. In an embodiment, when the computer system is initialized, the enable signal received by the control end of the control module is at a first level. Preferably, when the enable signal is at the first level, the MOSFET stays in an off state, and the first connecting terminal and the second connecting terminal of the control module are electrically isolated from each other. In another embodiment, when the computer system works normally, the enable signal received by the control end of the control module is at a second level. Preferably, when the enable signal is at the second level, the MOSFET stays in an on state, and the first connecting terminal and the second connecting terminal of the control module are electrically communicated with each other.

More specifically, when the system is initialized, it is preferred to prevent a voltage signal from the CPLD 14 from interfering with the port level voltages of the pins GP1 and GP2. In a preferred embodiment, for example, a reset signal of the system can serve as a control signal (or referred to as an enable signal) of the MOSFET1 and MOSFET2. When the enable signal is at a low level, the MOSFET1 and the MOSFET2 stay in an off state, and no electrically conductive channel is formed between the source and the drain of each MOSFET. Therefore, the pins GP1 and GP2 of the Southbridge chip 10 and the I/O port of the Complex Programmable Logic Device 14 are electrically isolated from each other, and thus an external interference will not be introduced into the pins GP1 and GP2 during initialization.

Furthermore, when the system stays in a normal operation state, i.e. when the reset signal is at a high level, the control end of the MOSFET1 and MOSFET2 presents a high level. Each MOSFET stays in an on state, and an electrically conductive channel is formed between the corresponding source and drain of the MOSFET. The pins GP1 and GP2 of the Southbridge chip 10 and the I/O port of the Complex Programmable Logic Device 14 are electrically communicated with each other. Therefore, during the normal operation period after the initialization is completed, the pins GP1 and GP2 serve as data input and data output ends to collaboratively enable a serial data transmission of the USB.

Those of ordinary skills in the art should understand that, although the MOSFET1 and MOSFET2 in FIG. 2 are configured to have a common control end CTRL, the present invention is not limited thereto. For example, control ends CTRL1 and CTRL2 can be respectively disposed on the respective MOSFETs for performing a switching control thereon respectively. All the arrangement forms of the circuits should be closely related to various function definitions of the multiplexing pin.

The control circuit of the present invention adopts the control module such as an MOSFET to switch on or switch off an electrical connection between the multiplexing pin and an external circuit, thereby avoiding an interference with the level voltage of the multiplexing pin during an initialization and reset period so as not to affect the mode setting during the system initialization, and further ensuring the enablement of the multiplexing function of the pin during a normal operation period. Therefore, the maintenance cost of the system is reduced and the stability and reliability of the operation are improved.

Although the above embodiments of the present invention have been described with reference to the accompanying drawings, it will be apparent to those skilled in the art that various modifications and variations can be made without departing from the scope or spirit of the present invention. Such modifications and variations shall fall within the scope of the present invention defined by the appended claims.

What is claimed is:

1. A multiplexing pin control circuit for a computer system, wherein the computer system has multiple chips, the multiplexing pin control circuit comprising:
a Southbridge chip having at least one multiplexing pin;
at least one control module, each of the at least one control module comprising:
a first connecting terminal electrically connected to the multiplexing pin;
a second connecting terminal; and
a control end for receiving an enable signal; and
a peripheral apparatus having an input/output (I/O) interface electrically connected to the second connecting terminal,
wherein, when the enable signal is at a first level, the peripheral apparatus and the second connecting terminal are electrically isolated from each other, and an operation mode of the multiple chips is determined according to a level value of the multiplexing pin; and
when the enable signal is at a second level, the peripheral apparatus and the second connecting terminal are electrically connected, and the multiplexing pin serves as a data output of a universal serial bus (USB).

2. The multiplexing pin control circuit of claim 1, wherein the peripheral apparatus is a complex programmable logic device (CPLD).

3. The multiplexing pin control circuit of claim 1, wherein the control module further comprises a metal oxide semiconductor field effect transistor (MOSFET).

4. The multiplexing pin control circuit of claim 3, wherein a source of the MOSFET is connected to the first connecting terminal, a drain of the MOSFET is connected to the second connecting terminal, and a gate of the MOSFET is connected to the control end.

5. The multiplexing pin control circuit of claim 3, wherein, when the computer system is initialized, the enable signal is at the first level.

6. The multiplexing pin control circuit of claim 5, wherein, when the enable signal is at the first level, the MOSFET stays in an off state, and the first connecting terminal and the second connecting terminal are electrically isolated from each other.

7. The multiplexing pin control circuit of claim 3, wherein, when the computer system works normally, the enable signal is at the second level.

8. The multiplexing pin control circuit of claim 7, wherein, when the enable signal is at the second level, the MOSFET stays in an on state, and the first connecting terminal and the second connecting terminal are electrically communicated with each other.

9. The multiplexing pin control circuit of claim 1, wherein the enable signal is sent by the Southbridge chip.
